(19) United States
(12) Patent Application Publication
(10) Pub. No.: US 2015/0015456 A1
(43) Pub. Date: Jan. 15, 2015

(54) MULTI-DISPLAY DEVICE AND DISPLAY MODULES

(71) Applicants: Sharp Kabushiki Kaisha, Osaka-shi, Osaka (JP); TOHOKU UNIVERSITY, Sendai-shi, Miyagi (JP)

(72) Inventors: Tatsuo Uchida, Sendai-shi (JP); Yoshito Suzuki, Sendai-shi (JP); Tohru Kawakami, Sendai-shi (JP); Kazuo Sekiya, Sendai-shi (JP); Masahiro Nishizawa, Sendai-shi (JP); Takahiro Ishinabe, Sendai-shi (JP); Katsunori Ehara, Sendai-shi (JP); Yoshihiro Hashimoto, Osaka-shi (JP); Yasuhisa Itoh, Osaka-shi (JP); Yoshitaka Yamamoto, Osaka-shi (JP); Yutaka Ishii, Osaka-shi (JP)

(73) Assignee: TOUOKU UNIVERISTY, Sendai-shi, Miyagi (JP)

(21) Appl. No.: 14/377,969

(22) PCT Filed: Feb. 14, 2013
(86) PCT No.: PCT/JP2013/053575

§ 371 Date: Aug. 11, 2014

(30) Foreign Application Priority Data
Feb. 14, 2012 (JP) 2012-029876

(51) Int. Cl. G06F 3/14

(52) U.S. Cl. CPC G06F 3/1446
USPC 345/1.3

(57) ABSTRACT

A multi-display device (101) of the present invention includes fry-eye lens arrays (3), located between a plurality of liquid crystal modules (11) arranged in parallel and in a tiling manner and a diffusing element (12), which cause rays of light emitted from light source sections (2) and transmitted through the liquid crystal modules (11) to be condensed on the diffusing element (12) at a pitch that is wider than a pixel pitch of the liquid crystal modules (11). This makes it possible with a simple configuration to make seams between image modulation elements less conspicuous and give a satisfactory feeling of resolution.

### TECHNICAL FIELD

The present invention relates to a multi-display device that makes a large-screen display possible by having a tiling arrangement of liquid crystal modules.

### BACKGROUND ART

Currently, an extra-large screen display such as digital signage is achieved by a tiling arrangement of liquid crystal modules.

However, the seams between liquid crystal modules arranged in such a tiling manner are problematically so conspicuous as to lower display quality.

In order to solve this problem, technologies of making the seams between liquid crystal modules inconspicuous have been proposed.

For example, Patent Literature 1 discloses a technology of, with use of a precision cutting technique in the step of cutting seams in the process for manufacturing liquid crystal panels, making the seams between the liquid crystal panels less conspicuous by arranging the liquid crystal panels so that spaces between them are nearly as narrow as those between pixels.

Further, Patent Literature 2 discloses a technology of making joint parts (i.e. seams) between unit panels less conspicuous by placing, in the joint parts between the unit panels, panels constituted by organic LEDs.

However, the technology disclosed in Patent Literature 1 presents the following problem: Since the frame of each of the liquid crystal panels is narrower than the pitch between pixels, the frame area is extremely narrow, with the result that the liquid crystal panel is susceptible to the influence of its external environment and may therefore easily cause a display defect.

Further, the technology disclosed in Patent Literature 2 presents various problems due to the use of organic LEDs. That is, the cost rises simply as much as the organic LEDs are arranged. Further, unless the liquid crystal panels and the organic LEDs are matched in display quality (luminance, chromaticity, etc.), there will be a dramatic reduction in image display quality. Furthermore, unless the display life of the organic LEDs is equal in performance to the liquid crystal panels, there will be a reduction in image display quality due to change over time.

In an attempt to solve these problems, Patent Literature 3 discloses a multi-display device in which the seams between liquid crystal modules have been made less conspicuous without reduction in width of the frame area or use of organic LEDs at the seams.

As shown in FIG. 11, the multi-display device disclosed in Patent Literature 3 includes: an array of two displays 1001 and 1001′; a plurality of upright imaging means 1002 and 1002′; enlarging means 1003 and 1003′; and a screen 1004. The displays emit rays of light to the upright imaging means 1002 and 1002′. The upright imaging means 1002 and 1002′ transmit the rays of light as image information at unity magnification to the enlarging means 1003 and 1003′. The enlarging means 1003 and 1003′ project an array of enlarged images onto the screen 1004.

### CITATION LIST

Patent Literature 1
Japanese Patent Application Publication, Tokukaihei, No. 10-96911 A (Publication Date: Apr. 14, 1998)

Patent Literature 2
Japanese Patent Application Publication, Tokukai, No. 2007-192977 A (Publication Date: Aug. 2, 2007)

Patent Literature 3
Japanese Patent Application Publication, Tokukaihei, No. 6-95139 A (Publication Date: Apr. 8, 1994)

### SUMMARY OF INVENTION

### Technical Problem

However, the multi-display device disclosed in Patent Literature 3 needs for optical elements to serve as the upright imaging means and the enlarging means, thus inviting cost increases. In particular, it is difficult to fabricate large-area upright imaging means.

Further, the multi-display device disclosed in Patent Literature 3 has difficulty in achieving a satisfactory feeling of resolution of the images projected onto the screen 1004. A reason for this is as follows: The enlarged projection by the enlarging means 1003 and 1003′ of the images from the displays 1001 and 1001′ causes items of pixel information from the displays 1001 and 1001′ to be partially color-mixed on the screen 1004, thus causing a reduction in resolution.

The present invention has been made in view of the foregoing problems, and it is an object of the present invention to provide a multi-display device which does not use means that would invite cost increases and which, with a simple configuration, makes seams between liquid crystal modules less conspicuous and gives a satisfactory feeling of resolution.

### Solution to Problem

A multi-display device of the present invention is a multi-display device having a parallel and tiling arrangement of transmissive image modulation elements each having a plane arrangement of pixels, including: light source sections, located directly below centers of image display surfaces of the image modulation elements, which shine light on the image modulation elements, respectively; a diffusing element, located facing sides of the image modulation elements that face away from the light source sections, which diffuses the light thus shone; and imaging optical elements, located between the image modulation elements and the diffusing element, which cause rays of light emitted from the light source sections and transmitted through the image modulation elements to be condensed on the diffusing element at a pitch that is wider than a pixel pitch of the image modulation elements.

### Advantageous Effects of Invention

The multi-display device of the present invention brings about a remarkable effect of eliminating the use of conventional means (such as upright imaging means) that would invite cost increases and of, with a simple configuration, making the seams between image modulation elements less conspicuous and giving a satisfactory feeling of resolution.

### BRIEF DESCRIPTION OF DRAWINGS

FIG. 1 is a schematic cross-sectional view of a multi-display device according to Embodiment 1 of the present invention.

FIG. 2 is a plan view of the multi-display device shown in FIG. 1.

FIG. 3 is a schematic cross-sectional view of a liquid crystal module constituting a multi-display device according to Embodiment 2 of the present invention.

FIG. 4 is a schematic cross-sectional view of the multi-display device according to Embodiment 2 of the present invention.

FIG. 5 is a schematic cross-sectional view of a multi-display device according to Embodiment 3 of the present invention.

FIG. 6 is a schematic cross-sectional view of a multi-display device according to Embodiment 4 of the present invention.

FIG. 7 is a schematic cross-sectional view of a liquid crystal module constituting the multi-display device shown in FIG. 6.

FIG. 8 is a diagram for explaining a principle of condensation of light onto a diffuser panel in the liquid crystal module shown in FIG. 7.

FIG. 9 is a schematic cross-sectional view of a multi-display device according to Embodiment 5 of the present invention.

FIG. 10 is a schematic cross-sectional view of a multi-display device according to Embodiment 6 of the present invention.

FIG. 11 is a cross-sectional view schematically showing a conventional multi-display device.

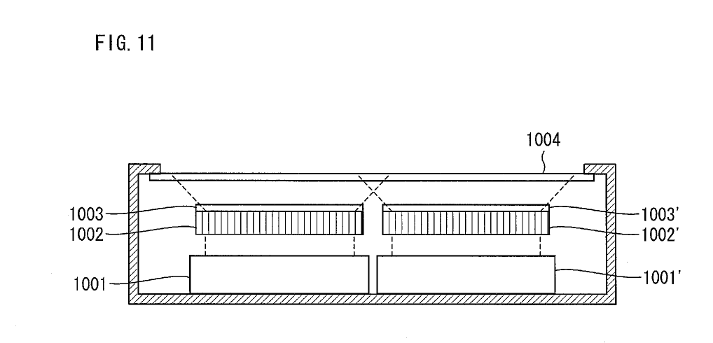

### DESCRIPTION OF EMBODIMENTS

### Embodiment 1

An embodiment of the present invention is described below.

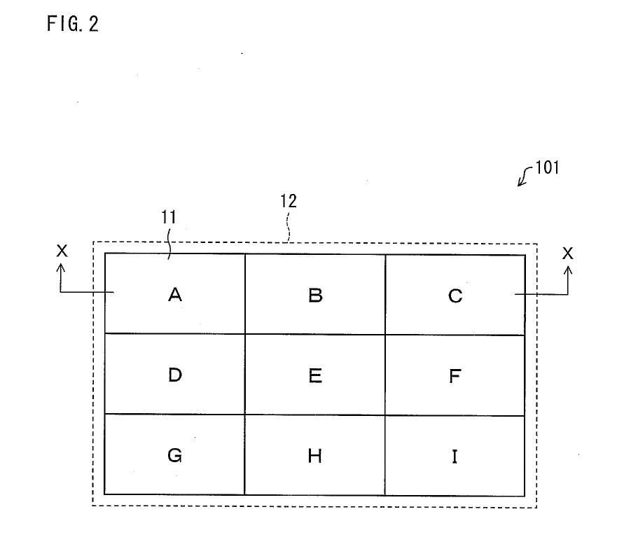

FIG. 2 shows a plan view of a multi-display device 101 according to the present embodiment.

The multi-display device 101 achieves a large-screen display by having a parallel and tiling arrangement of liquid crystal modules (display modules) 11 as shown in FIG. 2. The liquid crystal modules, arranged in such a tiling manner, are covered with a diffuser panel 12 (diffusing element) that functions as a screen. This allows images from the liquid crystal modules 11 to be projected onto the diffuser panel 12 and joined to each other on a diffusing surface of the diffuser panel 12, thus achieving a large-screen display.

Normally, in the case of a large-screen display carried out by a tiling arrangement of liquid crystal modules 11, those regions on the screen being displayed which correspond to the seams between the liquid crystal modules 11 are problematically so conspicuous as to lower display quality.

In order to solve this problem, the present invention provides each of the liquid crystal modules 11 with a mechanism that prevents such a problem from occurring.

(Details of the Liquid Crystal Modules 11)

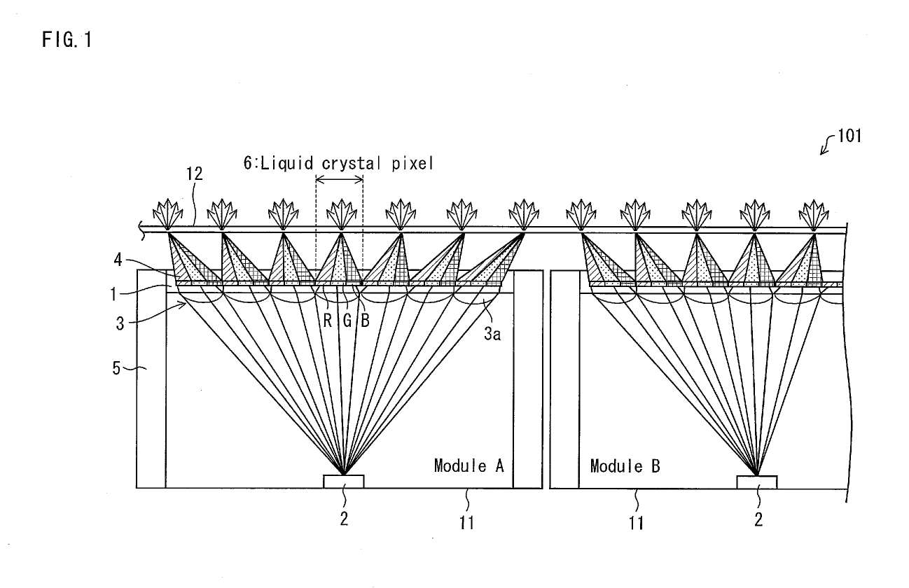

FIG. 1 is a cross-sectional view of the multi-display device 101 shown in FIG. 2 as taken along the line X-X. In FIG. 1, the modules A and B correspond to the signs shown in FIG. 2. Since the modules A and B are identical in configuration to each other, they are described as “liquid crystal modules 11” for convenience of explanation.

As shown in FIG. 1, each of the liquid crystal modules includes: a liquid crystal panel (image modulation element) 1; a light source section 2, constituted by a white LED (W-LED), which serves as a light-emitting section for illuminating the liquid crystal panel 1 from behind; a fry-eye lens array (imaging optical element) 3 provided facing a side of the liquid crystal panel 1 that faces the light source section 2; and a frame section 5, which serves to support the liquid crystal panel 1 and to prevent light from the light source section 2 from leaking out.

The liquid crystal panel 1, constituted by a transmissive liquid crystal display element having a planar arrangement of pixels, is configured to display an intended picture by controlling the transmittance of illuminating light from the light source 2 according to a video source. It should be noted that the liquid crystal panel 1 is not limited to any particular driving scheme, provided that it is a transmissive liquid crystal display element.

The light source section 2 is located directly below substantially the central part (directly-below-the-center position) of a display screen (image display surface) of the liquid crystal module 11. FIG. 1 shows an example where the light source section 2 is a single white LED. However, the present invention is not limited to such an example. The light source section 2 may be an arrangement of white LED light sources or an arrangement of LED light sources that emit lights of different dominant wavelengths from each other (i.e. that emit RGB colors of light, respectively), provided it is located directly below the central part of the display screen. Each of the white LED light sources may take the form of a blue LED chip having applied thereonto a fluorescent material that emits yellow light or the form of a blue LED chip having applied thereonto a plurality of fluorescent materials that have peaks at a plurality of wavelengths such as red and green. Alternatively, the light source section 2 does not need to be an LED light source, but may be an organic EL light located directly below the central part of the display screen of the liquid crystal module 11.

Further, the light source section 2 is placed at a certain distance from the liquid crystal panel 1 so that the light source section 2 can illuminate the liquid crystal panel 1 entirely from behind. It is the aforementioned frame section 5 that is needed to maintain the distance between the liquid crystal panel 1 and the light source section 2 at an appropriate value.

The fry-eye lens array 3 is constituted by a planar arrangement of lenses 3a placed at a distance from each other that corresponds to the pitch between pixels (width of each liquid crystal pixel 6) of the light crystal panel 1 and planarly arranged in a position adjacent to the liquid crystal panel 1. In FIG. 1, the fry-eye lens array 3 is provided facing the back side of the liquid crystal panel 1, i.e. the side of the liquid crystal display panel 1 that faces the light source section 2.

Each of the lenses 3a is a convex lens, and has its focal position adjusted to be on the diffusing surface of the diffuser panel 12.

It should be noted that the diffuser panel 12 has a role to expand angle characteristics so that light having passed through the liquid crystal panel 1 can be recognized from anywhere by an observer, and is equivalent to the screen of a projection display device.

With attention focused on rays of light that are condensed at their respective positions on the diffuser panel 12, rays of light emitted from the light source section 2 pass through the fry-eye lens array 3, thereby passing through only their corresponding liquid crystal pixels 6 of the liquid crystal panel 1, respectively. That is, each item of pixel information from the liquid crystal panel 1 has only a ray of light having passed through a lens 3a of the fry-eye lens array 3 that corresponds to that one of the liquid crystal pixels 6 which corresponds to the item of pixel information.

Further, the liquid crystal panel includes a CF (color filter) panel 4 for a color display. Moreover, each of the liquid crystal pixels 6 of the liquid crystal panel 1 is constituted by picture elements (R picture element, G picture element, B picture element) of different colors from each other, and the color of each of the liquid crystal pixels 6 can be expressed by adjusting the amounts of rays of light that pass through their corresponding picture elements of that pixel.

This allows the rays of light having passed through the liquid crystal pixels 6 of the liquid crystal panel 1 to be condensed at different places on the diffuser panel 12 with the pixels having items of color information that they are supposed to express, respectively.

(Restrictions on the Maximum Angle of Passage Through the Fry-Eye Lens Array 3)

In FIG. 1, it is preferable that the angle of a ray of light emitted from the light source section 2 and entering the fry-eye lens array 3 be at most 40 degrees or less with respect to the perpendicular to each of the lenses 3a. If the angle of emission from the light source section 2 is greater than 40 degrees, the ray of light that enters the fry-eye lens array 3 goes off the optical axis, with the result that an aberration called a curvature of field occurs. Normally, a curvature of field is eliminated generally by making an aberration correction with a plurality of lens systems, but such an aberration correction is not feasible from the standpoint of manufacturing cost. An aberration correction can also be made by aspherization of a lens, but in a case where there is only one lens interface, the improvement effect is limited. For these reasons, it is more preferable that the angle of a ray of light entering the fry-eye lens array 3 be at most 40 degrees with respect to the perpendicular to each of the lenses 3a. It should be noted that for condensation of light with the lenses 3a remaining as spherical lenses without being aspherized, it is even more preferable that the angle of a ray of light entering the fry-eye lens array 3 be at most 30 degrees with respect to the perpendicular to each of the lenses 3a.

The preferred angle of a ray of light emitted from the light source section 2 and entering a lens 3a of the fry-eye lens array 3 applies to each of the embodiments described below, as well as the present embodiment.

(Necessity of the Diffuser Panel 12)

Since the multi-display device 101 of the present invention uses the fry-eye lens array 3 to condense rays of light, light passing through the liquid crystal panel 1 is condensed toward the front to a certain degree. Therefore, when an image from the multi-display device 10 is observed at a visual angle that is not 90 degrees (i.e. from an oblique angle), much of the light does not reach, with the result that it becomes hard to see a display in the screen.

In order to solve this problem, it is preferable that the diffuser panel 12 be placed facing a side of the liquid crystal module 1 that faces the observer. That is, it is preferable that the diffuser panel 12 be placed facing a side of the liquid crystal panel 1 (image modulation element) that faces away from the light source section 2.

Further, in a case where the diffuser panel 12 further has angle-of-incidence independent diffusion characteristics (i.e. a property in which a distribution of intensities of diffusion during passage through a diffuser plate is constant regardless of the angle of incidence of a ray of light entering the diffusing element), rays of light that are condensed on the diffuser panel 12 with different angular distributions come to have the same diffusion characteristics, with the favorable result that improvement in display quality is expected.

(Measures Taken by the Diffuser Panel 12 Against Outside Light)

Furthermore, for higher image quality, it is possible to take measures to suppress back scattering of outside light by the diffuser panel 12 located on the surface. The diffuser panel 12 functions to cause light coming from the side of the liquid crystal panel 1 to be diffused toward the observer. Meanwhile, the diffuser panel 12 functions to cause light coming from the side of the observer to be transmitted and diffused toward the liquid crystal panel 1 and to be reflected and diffused toward the observer. This reflex action is called “back scattering of outside light”. An observation of this reflected and diffused light in combination with a normal image display transmitted through the liquid crystal panel 1 causes the image to look excessively bright, thus inviting a reduction in image quality.

Back scattering can be suppressed, for example, by providing, in a region on the diffuser panel 12 where rays of light having passed through the liquid crystal pixels 6 are not condensed, a film that absorbs outside light. The film that absorbs outside light suppresses back scattering of outside light by the diffuser panel 12. Meanwhile, the rays of light having passed through the liquid crystal pixels 6 are diffused without being absorbed by the film that absorbs outside light. This makes it possible to prevent a reduction in image quality.

Alternatively, back scattering can be suppressed, for example, by providing circularly polarizing plates on both sides of the diffuser panel 12. The circularly polarizing plates are each constituted by a linear polarizer and a quarter wavelength plate. In a case where circularly polarizing plates are provided on the upper and lower sides of the diffusing element, it is preferable that the quarter wavelength plate of each of the circularly polarizing plates face the diffuser panel 12.

It should be noted that the configuration in which the diffuser panel 12 is provided or the diffuser panel 12 and the circularly polarizing plates are provided is applicable to each of the embodiments described below, as well as the present embodiment, and back scattering of outside light may be suppressed by any method other than those mentioned above.

(Distance between Pixels Constituting a Liquid Crystal Pixel 6)

A ray of light passing through the lens 3a of the fry-eye lens array 3 that exits on the leftmost side of the module A passes through the liquid crystal pixel 6 that exists on the leftmost side in the liquid crystal panel 1. It should be noted here that the amount of a ray of light that passes through an opening in the blue (B) picture element is smaller than the amount of a ray of light that passes through an opening in the green (G) picture element. This is because the distance between the red (R) picture element and the G picture element, the distance between the G picture element and the B picture element, and the distance between the B picture element and the R picture element are all the same.

Normally, each single one of the liquid crystal pixels 6 of the liquid crystal panel 1 needs to be passed through only by a ray of light with an angular distribution of principle ray directions, and at least between one liquid crystal pixel 6 and another liquid crystal pixel 6, there must be a region that is free of a ray of light having passed through a lens 3a of the fry-eye lens array 3. The aforementioned problem undesirably occurs in a case where this region is wider than the width of a BM (black matrix: black mask layer) existing between B and R picture elements.

Therefore, in the present embodiment and the other embodiments described below, such a configuration is preferable that the BM width between pixels is wider than the BM width between picture elements. The term “BM width between picture elements” refers to the pitch between picture element, and in FIG. 1, the BM width between R and G picture elements and the BM width between G and B picture elements are examples. The term “BM width between pixels” refers to the pitch between pixels and, in FIG. 1, corresponds to the BM width between B and R picture elements.

(Effects)

In the multi-display device 101 thus configured, as shown in FIG. 1, rays of light emitted from the light source section 2 pass through the fry-eye lens array 3, thereby passing through the liquid crystal pixels 6 in the liquid crystal panel 1 that correspond respectively to the lenses 3a of the fry-eye lens array 3. It should be noted here that the rays of light emitted from the light source section 2 strike the lenses 3a of the fry-eye lens array 3 at different angles, respectively, and even after passage through the lenses 3a, the rays of light are condensed on the diffusing surface of the diffuser panel 12 in different principal ray directions, respectively.

Therefore, since the rays of light having passed through the liquid crystal panel 1 are condensed on the diffusing surface of the diffuser panel 12, they are each condensed into a region (diffusing surface of the diffuser panel 12) that is larger as a whole than the display screen of a single liquid crystal module 11.

In this way, the display screen of each liquid crystal module 11 is projected in an enlarged manner on the diffusing surface of the diffuser panel 12, i.e. the outermost/topmost surface of the multi-display device 101. This eliminates the need to make the frame section 5 of each liquid crystal module 11 thinner than necessary, and makes a seamless large-screen display possible.

The foregoing description has been given on the assumption of the module A as a liquid crystal module 11. However, a module B that is adjacent to the module A is exactly the same in configuration as the liquid crystal module 11. That is, rays of light having passed through the liquid crystal panel of the module B are each condensed into a region that is larger as a whole than the display screen.

In this way, rays of light from the two modules A and B are diffused by the diffuser panel 12 in the same plane. That is, an observer who looks at the multi-display device 101 recognizes not the display screens of the modules A and B but the diffusing surface of the diffuser panel 12 on the outermost/topmost surface. On the diffuser panel 12 on the outermost/topmost surface, rays of light passing through the modules A and B are condensed into regions that are larger than the respective display screens.

At this point in time, in a case where the gap between the position of condensation of pixel information on the outermost circumference of the module A and the position of condensation of pixel information on the outermost circumference of the module B is substantially equal to the gap between the position of condensation of each item of pixel information and the position of condensation of the other item of pixel information in each of the modules, an observer who looks at the multi-display device 101 becomes able to recognize images having passed through the two modules A and B as if they were a single item of image information.

Further, since the items of pixel information on the respective modules A and B are condensed at substantially one point, it becomes possible to display an image with high resolving power.

For the reasons stated above, the multi-display device 101 thus configured brings about a remarkable effect of eliminating the use of conventional means (such as the upright imaging means) that would invite cost increases and of, with a simple configuration, making the seams between liquid crystal modules 41 less conspicuous and giving a satisfactory feeling of resolution.

In the present Embodiment 1, an example has been shown where each of the liquid crystal modules 11 has its light source section 2 located directly below an area near the center of the display screen. In the case of such a configuration, an increase in the size of the liquid crystal module 11 makes it necessary to increase the amount of light that is emitted by the light source section 2 and lengthen the distance from the light source section 2 to the liquid crystal panel 1. For this reason, in the case of the multi-display device 101 shown in the present Embodiment 1, a preferred size of the liquid crystal module 11 is at most 10 to 15 inches diagonally.

For realization of a large-screen display device with use of a plurality of liquid crystal modules 11 of a larger size, e.g. liquid crystal modules 11 measuring 40 or 60 inches diagonally, it is preferable to use a configuration of Embodiment 2 described below.

### Embodiment 2

Another embodiment of the present invention is described below.

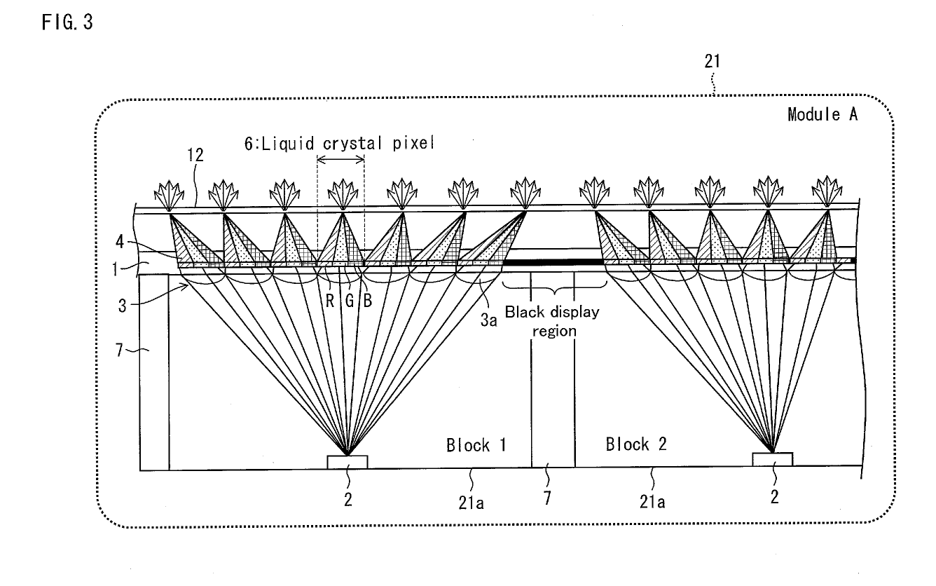

FIG. 3 shows a schematic cross-sectional view of a liquid crystal module 21 constituting a multi-display device 201 according to the present embodiment.

As shown in FIG. 3, the liquid crystal module 21 is constituted by a parallel arrangement of light source sections 2 in a plurality of blocks 21a. That is, the liquid crystal module 21 is constituted by dividing a single liquid crystal module 21 into a plurality of units each of which serves as a block 21a and providing a single light source section 2 in each of the blocks 21a.

(Details of the Blocks 21a)

The light source section 2 in each block 21a is located directly below substantially the central part of a portion of the display screen for which that block 21 is responsible. The light source sections 2 are identical in configuration to that of Embodiment 1, and as such, they are not described here. For convenience of explanation, the blocks are referred to as “blocks 21a” when it is not necessary to distinguish between them, and they are referred to as “blocks 1 and 2” when it is necessary to distinguish between them.

Further, the other components of each of the blocks 21a, namely the fry-eye lens array 3 and the diffuser panel 12, are also identical in configuration to those of Embodiment 1, and as such, they are not described here.

As shown in FIG. 3, the blocks 21a are substantially identical in configuration to the liquid crystal modules 11 of Embodiment 1. The blocks 21a differ from the liquid crystal modules 11 of Embodiment 1 in that a light-blocking sections 7 is provided in a space between each of the blocks 21a and the other.

The light-blocking section 7 is provided, for example, for the purpose of preventing light from the light source section 2 in the block 1 from striking the fry-eye lens array 3 of the block 2. If light from the light source section 2 in the block 1 strikes the fry-eye lens array 3 of the block 2, the light passes through the fry-eye lens array 3 and then travels to a place that is different from the position on which it is supposed to be condensed, to be diffused by the diffuser panel 12. At this point in time, the light is color-mixed with light emitted from the light source section 2 of the block 2, thus inviting a reduction in image quality.

Another point of difference from Embodiment 1 is that there is an unused region (black display region) within the display screen of the liquid crystal module 21.

That is, whereas the display screen of each liquid crystal module 11 and its fry-eye lens array 3 are substantially equal in outer dimensions to each other in Embodiment 1, the outer dimensions of a fry-eye lens array 3 is about equal to the size of each block 21a in Embodiment 2, so each liquid crystal panel 1 is larger than a single block. This causes a place in the liquid crystal panel 1 that corresponds to the light-blocking section 7 between blocks 21a to be a region where no image is displayed. As for this region, where a black display is carried out, a conventional liquid crystal panel can be directly applied. Further, wires for active-matrix driving of the liquid crystal panel 1 may be laid over the region where no image is displayed.

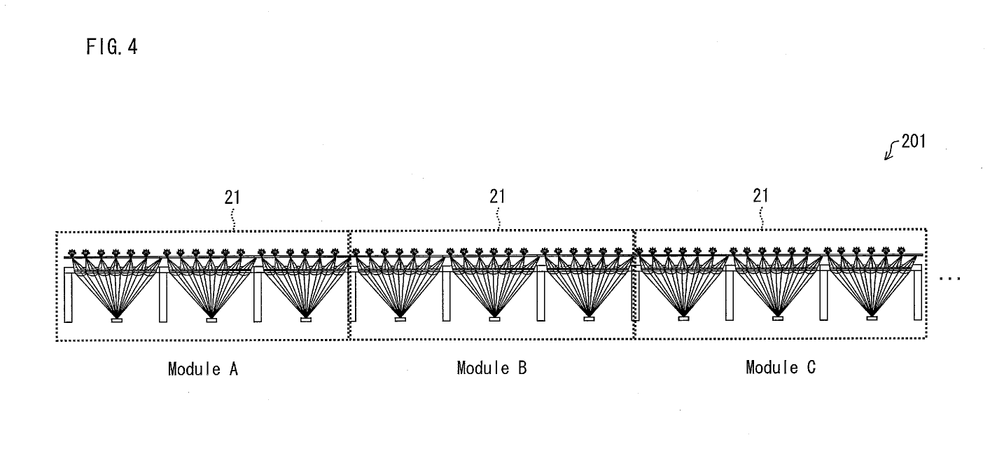

FIG. 4 shows a schematic cross-sectional view of a multi-display device 201 having a parallel and tiling arrangement of liquid crystal modules 21 shown in FIG. 3.

As shown in FIG. 4, the multi-display device 201 has a parallel and tiling arrangement of liquid crystal modules 21 each of which has its inner part configured as shown in FIG. 3, thereby making it possible to cause a large-screen display that is larger than a single liquid crystal module 21 to be displayed as an integrated image.

This brings about a great advantage of making the multi-display device 201 thinner. For example, in the case of a 120-inch large-screen display device made by a 3×3 parallel arrangement of liquid crystal modules of Embodiment 1 each measuring 40 inches diagonally, each of the liquid crystal panels 1 and its corresponding light source section 2 needs to be placed at a distance of at least 400 mm from each other. In the present embodiment, on the other hand, in the case of a 120-inch large-screen display device made, for example, by dividing a single 40-inch liquid crystal module 21 into 5×9 blocks and arranging the liquid crystal modules 21 3×3 in parallel, each of the liquid crystal panels 1 and its corresponding light source section 2 needs only be placed at a distance of at least 45 mm from each other. For this reason, a large-screen display can be achieved more compactly by a parallel arrangement of liquid crystal modules 21 described in the present embodiment than by the application of liquid crystal modules 11 described in Embodiment 1.

Although FIG. 3 shows an example where fry-eye lens arrays 3 are used in the blocks 1 and 2, respectively, these fry-eye lens arrays 3 may be replaced by a single large-sized fry-eye lens. That is, the block size and the fry-eye lens size do not necessarily need to match, and it is desirable that fry-eye lenses be fabricated in such a size that manufacturing cost merit can be exerted most.

(Light-blocking Section, Light-blocking Region)

In the present embodiment, as mentioned above, the light-blocking section 7 (or light-blocking region (not illustrated) in the liquid crystal panel 1) is provided for the purpose of preventing light from a light source section 2 corresponding to a single block 21a from striking an adjacent block 21a. However, such a configuration is unnecessary if all of the light from the light source section 2 strikes only the inside of the corresponding block 21a.

However, in consideration of various manufacturing variations after all, there is a case where it becomes necessary to prevent light from a light source section 2 corresponding to a single block 21a from striking an adjacent block 21a. There are a plurality of possible options for achieving a light-blocking region in each liquid crystal panel 1.

A first option is a case where image displays corresponding to the light-blocking regions are all black displays. In this case, although the number of pixels that are displayed on the diffuser panel 12 is smaller than the total number of pixels of the plurality of liquid crystal modules, it becomes possible to divert existing liquid crystal modules.

A second option is to place a light-blocking member, instead of pixels, in a region corresponding to a light-blocking region. Examples of a light-blocking member in the liquid crystal panel 1 include a wiring member such as a TFT, a BM (black mask) of a color filter, and a member (photospacer that is used in an existing liquid crystal display) for retaining the thickness between liquid crystal layers. These members may be used alone or in combination (lamination). This makes it possible to match the number of pixels that are displayed on the diffuser panel 12 and the total number of pixels of the plurality liquid crystal modules.

(Effects)

In each of the blocks 21a of the multi-display device 201 thus configured, as shown in FIG. 3, rays of light emitted from the light source section 2 pass through the fry-eye lens array 3, thereby passing through the liquid crystal pixels 6 in the liquid crystal panel 1 that correspond respectively to the lenses 3a of the fry-eye lens array 3. It should be noted here that the rays of light emitted from the light source section 2 strike the lenses 3a of the fry-eye lens array 3 at different angles, respectively, and even after passage through the lenses 3a, the rays of light are condensed on the diffusing surface of the diffuser panel 12 in different principal ray directions, respectively.

Therefore, since the rays of light having passed through the liquid crystal panel 1 are condensed on the diffusing surface of the diffuser panel 12, they are each condensed into a region (diffusing surface of the diffuser panel 12) that is larger as a whole than the size of a single block 21a constituting a liquid crystal module 21.

Further, with attention focused on rays of light that are condensed at their respective positions on the diffuser panel 12, rays of light emitted from the light source section 2 pass through the fry-eye lens array 3, thereby passing through only their corresponding liquid crystal pixels 6 of the liquid crystal panel 1, respectively. That is, each item of pixel information from the liquid crystal panel 1 has only a ray of light having passed through a lens 3a of the fry-eye lens array 3 that corresponds to that one of the liquid crystal pixels 6 which corresponds to the item of pixel information. Further, the liquid crystal panel includes a CF (color filter) panel 4 for a color display. Moreover, each of the pixels of the liquid crystal panel 1 is constituted by picture elements (R picture element, G picture element, B picture element) including color filters of different colors respectively, and the color of each of the pixels can be expressed by adjusting the amounts of rays of light that pass through their corresponding picture elements of that pixel.

This allows the rays of light having passed through the liquid crystal pixels 6 of the liquid crystal panel 1 to be condensed on the diffuser panel 12 with the pixels having items of color information that they are supposed to express, respectively.

The foregoing description has been given on the assumption of a single block 21a (block 1) of the liquid crystal module 21. However, the block 2, which is adjacent to the block 2, is exactly the same in configuration as the block 21a. That is, rays of light having passed through the liquid crystal panel 1 of the block 2 are each condensed into a region that is larger as a whole than the display screen.

In this way, rays of light from the two blocks 1 and 2 are diffused by the diffuser panel 12 in the same plane. That is, an observer who looks at the multi-display device 201 recognizes not the display screens of the liquid crystal modules 21 but the diffusing surface of the diffuser panel 12 on the outermost/topmost surface. On the diffuser panel 12 on the outermost/topmost surface, rays of light passing through the modules A and B are condensed into regions that are larger than the respective display screens.

At this point in time, in a case where the gap between the position of condensation of pixel information on the outermost circumference of the block 1 and the position of condensation of pixel information on the outermost circumference of the block 2 is substantially equal to the gap between the position of condensation of one item of pixel information and the position of condensation of another item of pixel information in each of the blocks, an observer who looks at the multi-display device 201 becomes able to recognize images having passed through the two blocks as if they were a single item of image information. Further, since the items of pixel information are condensed at substantially one point, it becomes possible to display an image with high resolving power.

Let it be assumed in FIG. 4 that each of the modules A, B, and C is constituted by three blocks and the distance between blocks is substantially equal to the gap between the position of condensation of one item of pixel information and the position of condensation of another item of pixel information as mentioned above. In a case where the gap between the position of condensation of pixel information on the outermost circumference of the right block of the module A and the position of condensation of pixel information on the outermost circumference of the left block of the module B is deemed to be substantially equal to the gap between the position of condensation of one item of image information and the position of condensation of another item of image information, an observer who looks at the multi-display device 201 becomes able to recognize images having passed through the two modules A and B as if they were a single item of image information. If the same condition can hold between the module B and the module C, it becomes possible to cause the observer to recognize an even larger image as a single item of image information, thus making it possible, in principle, to carry out an indefinitely-large seamless integrated display.

### Embodiment 3

Still another embodiment of the present invention is described below. The present embodiment describes an example where each light source section is constituted by three colors of LED, namely RGB LEDs, whereas each of the light source sections 2 employed in Embodiment 1 is a white LED.

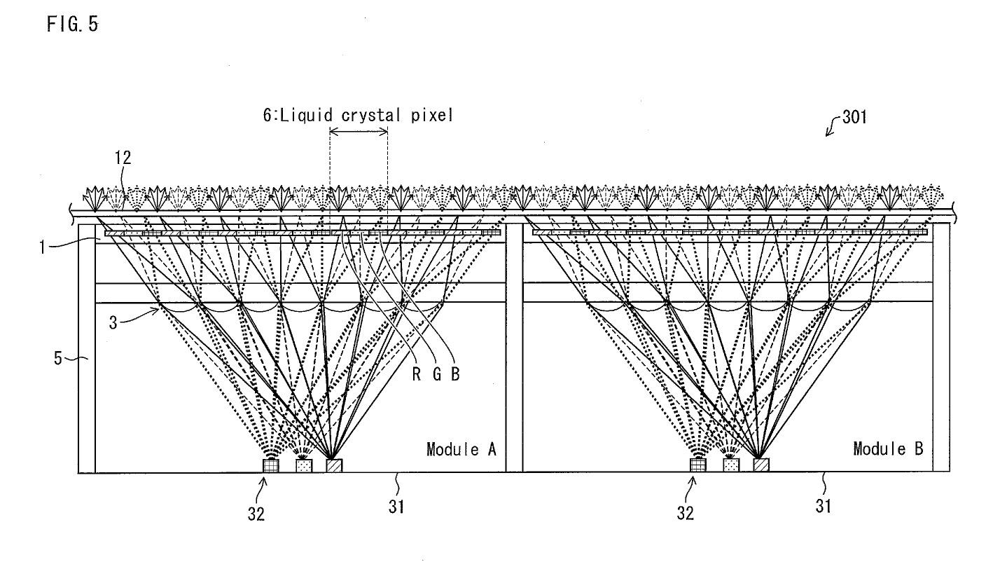

FIG. 5 shows a schematic cross-sectional view of liquid crystal modules 31 constituting a multi-display device 301 according to the present embodiment.

(Details of the Liquid Crystal Modules 31)

As shown in FIG. 5, each of the liquid crystal modules 31 has a light source section 32 located directly below substantially the central part of the display screen of the liquid crystal panel 1, as with the liquid crystal modules 11 of Embodiment 1. It should be noted here that the light source section 32 is constituted by LED light sources that emit RGB colors of light, respectively. These LED light sources are placed at spaces from one another. This allows rays of light that are emitted from the LEDs to strike the fry-eye lens array 3 at different angles, respectively.

In the example shown in FIG. 5, only three colors of RGB are used. However, without being limited thereby, combinations of colors and numbers of colors may be changed according to the picture elements constituting the pixels of the liquid crystal panel 1. Further, instead of the LED light sources, organic EL light sources that emit different colors of light may be disposed directly below the central part of the display screen of the liquid crystal panel 1.

The fry-eye lens array 3 is placed so that each of the lenses 3a has its focal position located on the diffusing surface of the diffuser panel 12.

The liquid crystal panel 1 is placed at such a height that rays of light emitted from the respective colors of LED and having passed through the lenses 3a of the fry-eye lens array 3 pass through spatially different positions. Doing so makes it possible to cause only respectively corresponding colors of light to pass through the picture elements constituting the liquid crystal pixels 6 of the liquid crystal panel 1, thus making it possible to eliminate a color filter that causes a great optical loss.

It should be noted that the diffuser panel 12 has a role to expand angle characteristics so that light having passed through the liquid crystal panel 1 can be recognized from anywhere by an observer, and is equivalent to the screen of a projection display device.

(Features)

A point of great difference between the present embodiment and Embodiments 1 and 2 is that whereas each of Embodiments 1 and 2 causes rays of light from a light source section 2 to pass through the pixels of each of the liquid crystal panels corresponding respectively to the lens arrays, the present embodiment causes different colors of light from a light source section 32 to pass through the respective colors of picture elements constituting the liquid crystal pixels 6 of each of the liquid crystal panels corresponding respectively to the lens arrays.

In the multi-display device 301 thus configured, rays of light emitted from the respective colors of RGB light sources of a light source section 32 strike the fry-eye lens array 3 at different angles, they are condensed in different directions after passing through the fry-eye lens array 3. The rays of light emitted from the respective colors of RGB light sources are present in the same plane immediately after passing through the lenses 3a of the fry-eye lens array 3, the rays of RGB light come to pass through different planes as they travel away from the fry-eye lens array 3.

For this reason, by placing a pixel region of the liquid crystal panel 1 at such a height that rays of RGB light pass through different planes, it is made possible to cause respectively corresponding colors of light to pass through the respective colors of picture elements constituting the pixels of the liquid crystal panel 1. At the same time, since the fry-eye lens array 3 has its focal position located in a diffusing position of the diffuser panel 12, the rays of light having passed through the respective picture elements constituting the liquid crystal pixels 6 are condensed at different positions on the diffuser panel 12 and each condensed into a region that is larger as a whole than the liquid crystal module.

Therefore, in the case of a multi-display device 301 constituted by a parallel arrangement of similar liquid crystal modules, the observer becomes able to recognize them as a single seamless item of image information, and at the same time, the observer can view picture element information without color mixture even in a case where the observer looks closely at the multi-display device 301. This makes it possible to achieve a display with high resolving power.

(Resolving Power)

As used herein, the term “resolving power” refers to an index of whether or not an image looks clear to an observer who looks at the screen. The higher the resolving power is, the clearer the image can be said to be.

Although there is a difference between Embodiments 1 and 2 and the present embodiment as to whether the rays of light reaching the diffuser panel 12 are condensed for each item of pixel information or for each item of picture element information, they are actually at substantially equal levels of resolving power.

The most important thing to resolving power is that adjacent items of pixel information are not color-mixed with each other. If adjacent items of pixel information reach the diffuser panel 12 while being partially color-mixed with each other, the observer will end up recognizing the items of pixel information as a blurred image.

Whether in Embodiments 1 and 2 or the present embodiment, adjacent items of pixel information will not be color-mixed with each other, because, in terms of units of pixels, there appears a region on the diffuser panel 12 between adjacent items of pixel information where a ray of light does not reach. This makes it possible to display an image with high resolving power whether in Embodiments 1 and 2 or the present embodiment. Therefore, in terms of a large-screen display system obtained by arranging simple projection systems in a tiling manner, the present invention can be said to be a more advantageous technology in terms of resolving power.

(Effects)

With attention focused on rays of light that are condensed at their respective positions on the diffuser panel 12 in the multi-display device 301 according to the present embodiment, rays of light emitted from the light source section 32 pass through the fry-eye lens array 3, thereby passing through their corresponding picture elements constituting the liquid crystal pixels 6 of the liquid crystal panel 1, respectively. That is, each item of picture element information from the liquid crystal panel 1 has only a ray of light having passed through its corresponding picture element. Therefore, even in the case of a liquid crystal panel 1 configured not to include a color filter in each picture element, the color of each pixel can be expressed by adjusting the amount of light that passes through each picture element. This makes it possible to carry out a full-color display without using a color filter.

Therefore, the multi-display device 301 according to the present embodiment makes it possible to display an integrated image without causing an observer to view a seam between liquid crystal modules, and to achieve lower electric power consumption by drastically reducing an optical loss that is absorbed by a color filter.

While what has so far been mentioned concerns the module A. Exactly the same applies to a module B that is adjacent to the module A. That is, rays of light having passed through the liquid crystal panel of the module B are each condensed into a region (diffusing surface of the diffuser panel 12) that is larger as a whole than the display screen.

Rays of light from the two modules A and B are diffused by the diffuser panel 12 in the same plane. That is, an observer who looks at the multi-display device 301 recognizes not the display screens of the modules A and B but the diffusing surface of the diffuser panel 12 on the outermost/topmost surface. On the diffuser panel 12 on the outermost/topmost surface, rays of light passing through the modules A and B are condensed into regions that are larger than the respective display screens.

At this point in time, in a case where the gap between the position of condensation of pixel information on the outermost circumference of the module A and the position of condensation of pixel information on the outermost circumference of the module B is substantially equal to the gap between the position of condensation of one item of pixel information and the position of condensation of another item of pixel information in each of the modules, an observer who looks at the multi-display device 301 becomes able to recognize images having passed through the two modules A and B as if they were a single item of image information. Further, since the items of pixel information are condensed at substantially one point, it becomes possible to display an image with high resolving power.

Alternatively, in the present embodiment, as in Embodiment 2, a single liquid crystal module may be divided into a plurality of blocks and a light source section 32 may be disposed in each of the blocks. In this case, a reduction in the thickness of the multi-display device 301 can be achieved by causing rays of light passing through the respective blocks to be condensed as items of picture element information at substantially equal intervals on the diffuser panel 12.

(Presence or Absence of a Color Filter)

In the present embodiment, as mentioned above, a multi-display device 301 that does not need to be provided with a color filter has been described. Now, the presence or absence of a color filter is discussed.

In the present embodiment, as shown in FIG. 5, only rays of light emitted from R, G, and B LEDs (light source section 32) corresponding to picture elements constituting a liquid crystal pixel 6 serving as a light passage section pass through the picture elements, respectively. In this state, by driving the liquid crystal panel 1 corresponding to the picture elements by applying drive voltage via a driving element, it is made possible to carry out a full-color display, ideally without a color filter.

However, in reality, due to such problems as manufacturing variations that make it impossible to manufacture or assemble optical components as designed and manufacturing costs whose consideration makes it necessary to manufacture optical components that are, more or less, not shaped as designed, there might be a case where it is difficult to condense only rays of light corresponding to the liquid crystal pixels 6 of the liquid crystal panel 1 constituting a pixel array. In that case, at worst, a reduction in display quality may be invited. Such a situation can be avoided by providing a CF panel 4 (color filter) as in Embodiments 1 and 2. However, use of a color filter layer causes the transmittance to be approximately 90% even at a wavelength at which light is transmitted, thus making it difficult to avoid an optical loss. Therefore, it is better not to use a color filter layer.

### Embodiment 4

Still another embodiment of the present invention is described below. The present embodiment describes an example where each light source section 2 is constituted by two white LEDs, whereas each of the light source sections 2 employed in Embodiment 1 is a white LED.

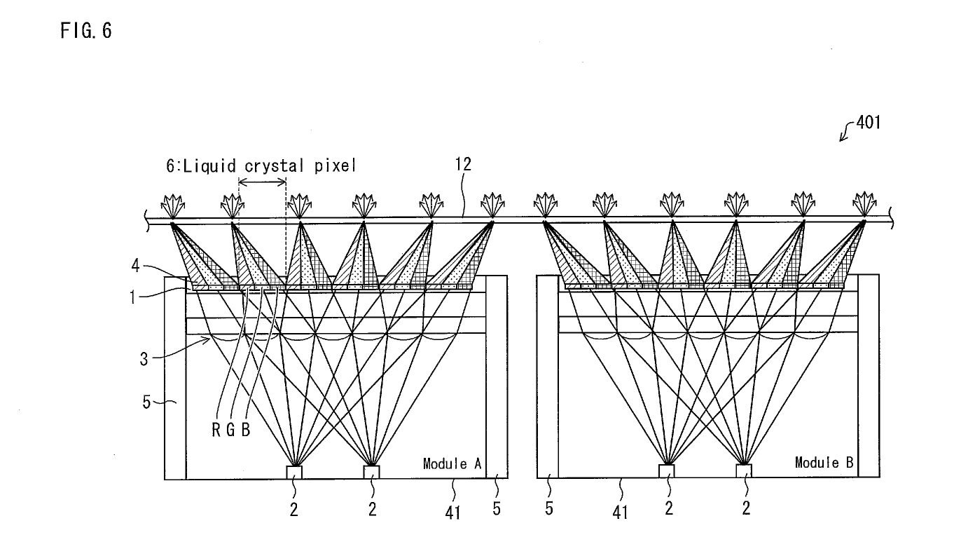

FIG. 6 shows a schematic cross-sectional view of liquid crystal modules 41 constituting a multi-display device 401 according to the present embodiment.

(Details of the Liquid Crystal Modules 41)

As shown in FIG. 6, each of the liquid crystal modules 41 has a plurality of light source section 2 (in FIG. 6, two light source sections 2) located directly below substantially the central part of the display screen of the liquid crystal panel 1, as with the liquid crystal modules 11 of Embodiment 1. These LED light sources are placed at spaces from each other. This allows rays of light that are emitted from the LEDs to strike the fry-eye lens array 3 at different angles, respectively.

The fry-eye lens array 3 is placed so that each of the lenses 3a has its focal position located on the diffusing surface of the diffuser panel 12. The pitch between lenses 3a of the fry-eye lens array 3 will be described in detail later.

The liquid crystal panel 1 is placed at such a height that rays of light having passed through the liquid crystal pixels 6 pass through spatially different positions. Doing so makes it possible to cause the rays of light passing through the liquid crystal pixels 6 of the liquid crystal panel 1 to be condensed at different places on the diffuser panel 12.

It should be noted that the diffuser panel 12 has a role to expand angle characteristics so that light having passed through the liquid crystal panel 1 can be recognized from anywhere by an observer, and is equivalent to the screen of a projection display device.

(Features)

A point of great difference between the present embodiment and Embodiments 1 to 3 is that whereas each of Embodiments 1 to 3 causes a ray of light from a single lens 3a of the fry-eye lens array 3 to pass through a liquid crystal pixel 6 (picture elements) of the liquid crystal panel 1 and causes the ray of light to be condensed on the diffuser panel 12, the present embodiment causes rays of light from two lenses 3a of the fry-eye lens array 3 to pass through a liquid crystal pixel 6 (picture elements) of the liquid crystal panel 1 and causes those rays of light to be condensed at one point on the diffuser panel 12.

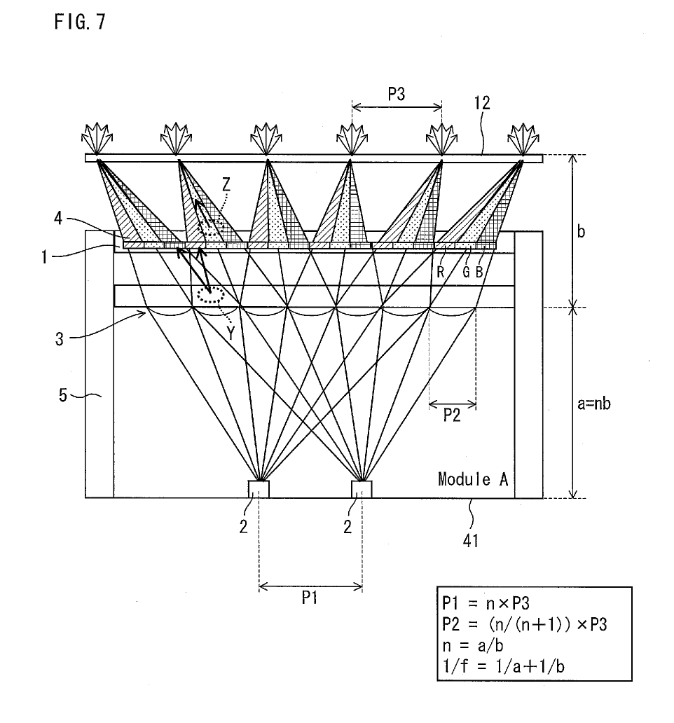

In the present embodiment, the point of difference needs only be achieved by setting the pitch P1 between two light source sections 2, the pitch P2 between lenses 3a of the fry-eye lens array 3, and the pitch P3 between condensed rays of light on the diffuser panel 12 to satisfy the conditions set forth in FIG. 7. It should be noted, in FIG. 7, that a is the distance from each of the light source sections 2 to the fry-eye lens array 3, that b is the distance from the fry-eye lens array 3 to the diffuser panel 12, and that n is the reduction ratio of the fry-eye lens array 3 and is a value that is calculated from a/b. Further, a and b both denote lengths calculated in terms of the refractive index of air. 1/n is the imaging scale ratio of the fry-eye lens array 3.

A logical explanation of the configuration according to which rays of light having passed through a plurality of lenses 3a of the fry-eye lens array 3 are condensed at one point on the diffuser panel 12 will be given later. In particular, one point of importance in the present embodiment is the placement of the liquid crystal panel 1.

That is, in the case of the foregoing configuration, rays of light emitted from light source sections 2 in different positions strike the lenses 3a of the fry-eye lens array 3 at different angles, they are condensed in different directions after passing through the lenses 3a. Immediately after passage through the lenses 3a of the fry-eye lens array 3, there exist a plurality of rays of light at different angles in a plane (as indicated by a dotted circle Y in the lens array in FIG. 7). With a little more distance from the lens array, there comes to exit only a ray of light at a single angle in a plane (as indicated by a dotted circle Z in the lens array in FIG. 7).

If the liquid crystal panel 1 is placed at the height of the dotted circle Y in the lens array in FIG. 7, rays of light with an angular distribution of a plurality of different principal ray directions with respect to a single liquid crystal pixel 6, and those rays of light reach different positions on the diffuser panel 12 and are diffused. This causes a single item of pixel information to exist in different positions and causes it to be color-mixed with an adjacent item of pixel information, thus inviting a reduction in resolving power.

Placing the liquid crystal panel 1 at the height shown in FIG. 7, only a ray of light with an angular distribution of a single principal ray direction passes through a single pixel, and this ray of light reaches only one place on the diffuser panel 12 and is diffuse (as shown in FIG. 7).

Further, in view of the module A as a whole, rays of light having passed through the liquid crystal panel 1 are each condensed into a region that is larger than the module A. In the case a parallel arrangement of similar liquid crystal modules, the observer becomes able to recognize them as a single seamless item of image information.

(Logical Explanation of Condensation of Rays of Light Having Passed Through a Plurality of Lens Arrays at One Point on a Diffusing Element)

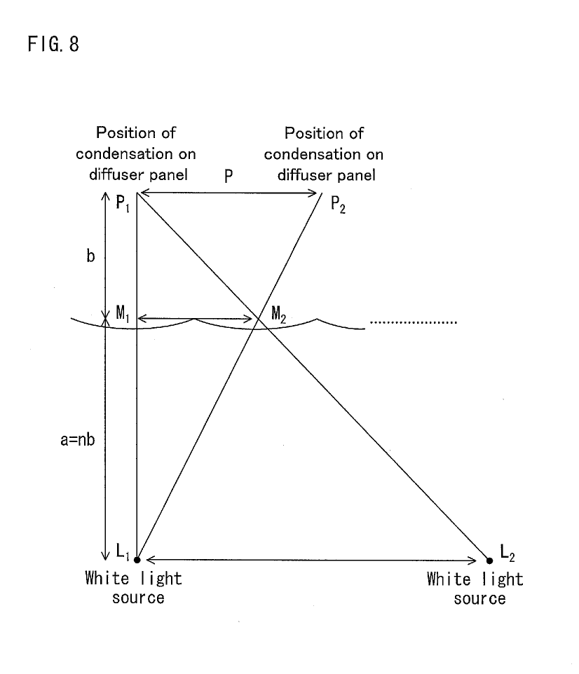

FIG. 8 is a schematic view for mathematically explaining rays of light passing through a lens 3a of a fry-eye lens array 3 from light source sections 2, such as those shown in FIG. 7, that are white light sources. FIG. 8 illustrates only the paths of those principal rays, contained in light (W light) reaching the diffuser panel 12 from the white light sources, which pass through the center of the lens 3a of the fry-eye lens array 3. FIG. 8 also omits a refractive phenomenon occurring due to a difference in index of refraction at the interface of the fry-eye lens array 3. It is assumed here that L1 and L2 denote the positions of the white light sources (light source sections 2) in FIG. 8, that M1 and M2 denote the centers of lenses 3a of the fry-eye lens array 3, and that P1 and P2 denote the positions of condensation on the diffuser panel 12.

First, in order for a ray of light from a single white light source to be condensed at a position of condensation on the diffuser panel 12, it is necessary that the triangle L1P1P2 and the triangle L1M1M2 be similar to each other as illustrated. In order for this similarity to be satisfied, it is necessary that Expression (1) hold as follows:

Line M1M2/Line L1M1=Line P1P2/Line L1P1 (1),

where the line M1M2 corresponds to the lens pitch between lenses 3a of the fry-eye lens array 3. Therefore, from Expression (1), Relational Expression (2) is derived as follows:

Line M1M2=Line L1M1×Line P1P2/Line L1P1 (2),

where the line L1M1=a=n×b, the line P1P2=P, and the line L1P1=a+b=(n+1)×b. Therefore, the line M1M2 is calculated as n×P/(n+1). Accordingly, in a case where the line M1M2, which is the lens pitch between lenses 3a of the fry-eye lens array 3, is n×P/(n+1), the rays of light from the white light sources can be condensed at different positions on the diffusing element.

Next, in order for rays of light from a plurality of white light sources to be condensed at one place, it is necessary that the triangle L1L2P1 and the triangle M1M2P1 be similar to each other as illustrated. In order for this similarity to be satisfied, it is necessary that Expression (3) hold as follows:

Line L1L2/Line L1P1=Line M1M2/Line M1P1 (3),

where the line L1L2 corresponds to the pitch between white light sources. Therefore, from Expression (3), Relational Expression (4) is derived as follows:

Line L1L2=Line L1P1×Line M1M2/Line M1P1 (4),

where the line L1P1=a+b=(n+1)×b and the line M1P1=b. With application of the relationship the line M1M2=n×P/(n+1) derived above, the line L1L2 is calculated as n=P. Accordingly, in a case where the line L1L2, which the pitch between white light sources, is n×P, the rays of light from the plurality of white light sources can be condensed at one place on the diffusing element.

These two results show that by setting the pitch between white light sources to be n×P and setting the lens pitch between lenses 3a of the fry-eye lens array 3 to be n×P/(n+1), rays of light from a single white source can be condensed at different positions on the diffusing element and, at the same time, rays of light from a plurality of white light sources can be condensed at one place on the diffusing element.

(Effects)

The multi-display device 401 according to the present embodiment makes it possible to cause an observer to view a seamless integrated image display in the case of a parallel arrangement of liquid crystal modules as in Embodiment 1 and, at the same time, brings about an effect of averaging out individual differences among the white LEDs (light source sections).

Embodiment 1 has no effective means for suppressing an individual difference, if any, between adjacent white LEDs (light source sections). On the other hand, in FIG. 7, for example, the present embodiment has two light source sections in each liquid crystal module 1. This causes rays of light from the two light source sections 2 to be averaged out as they reach a position of condensation on the diffuser panel 12. This makes the variation between the LEDs inconspicuous to an observer who looks at the multi-display device 401. This makes it possible to improve display image quality.

Further, in the present embodiment, as in Embodiment 2, a single liquid crystal module may be divided into a plurality of blocks and two light source sections 2 may be disposed in each of the blocks. This makes it possible to achieve a reduction in the thickness of the multi-display device 401.

Moreover, an individual difference in LED between blocks can be averaged out by disposing a plurality of LEDs (two light source sections) in each block. Therefore, the multi-display device 401 as a whole makes the difference in LED inconspicuous to an observer who looks at the multi-display device 401. This makes it possible to improve display image quality.

Furthermore, the configuration of the present embodiment can also be applied to the configuration of Embodiment 3. That is, by using a plurality of RGB-LED light sources as each light source section, placing the LED light sources at an appropriate distance from each other, lenses 3a of each fry-eye lens array 3 at an appropriate pitch from each other, and positions of condensation on the diffuser panel 12 at an appropriate distance from each other, and placing the liquid crystal panel 1 at a predetermined height, rays of light emitted from the light source sections 2 are allowed to pass through the lenses 3a of the fry-eye lens array 3, thereby passing through their corresponding picture elements constituting the liquid crystal pixels 6 of the liquid crystal panel 1, respectively. This lowers electric power consumption as in Embodiment 3 and, furthermore, averages out individual differences in LED among the colors of RGB, thus making it possible to improve display image quality.

### Embodiment 5

Still another embodiment of the present invention is described below.

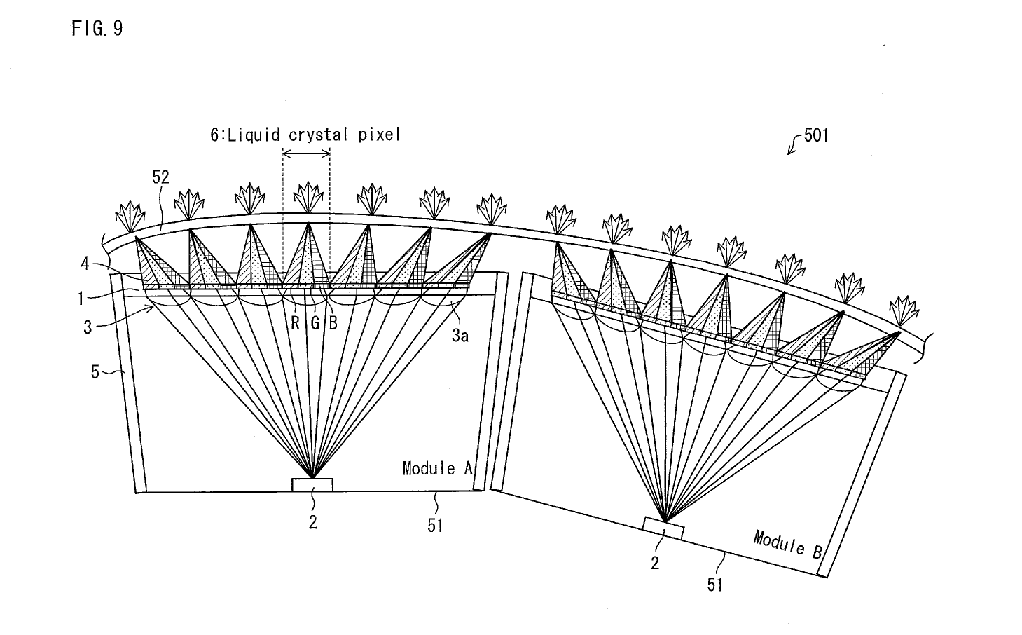

FIG. 9 shows a schematic cross-sectional view of a multi-display device 501 according to the present embodiment.

A point of great difference between the multi-display device 501 and the multi-display devices 101 to 401 described respectively above in Embodiment 1 to 4 is that as shown in FIG. 9, a diffuser panel 52, which is equivalent to the screen, does not have a planar surface but has a curved surface and the characteristics of the lenses 3a of each fry-eye lens array 3 that condense rays of light onto the diffuser panel 52 vary with location.

Details of a liquid crystal module 51 (modules A) constituting the multi-display device 501 are described.

(Details of the Liquid Crystal Module 51)

As shown in FIG. 9, the liquid crystal module 51, as with a liquid crystal module 11 of Embodiment 1, has its light source section 2 located directly below substantially the central part of the display screen of the liquid crystal panel 1. The light source section 2 used here is a white LED, as in Embodiment 1. The light source section 2 is the same as that of Embodiment 1, and as such, is not described here.

The lenses 3a of the fry-eye lens array 3 are planarly placed at a pitch corresponding to the pixel pitch between liquid crystal pixels 6 of the light crystal panel 1 and in positions near the liquid crystal panel 1.

Further, the focal position of each of the lenses 3a of the fry-eye lens array 3 is at a height from a lens surface of that lens 3a to a diffusing surface of the diffuser panel 52. The pitch between lenses 3a of the fry-eye lens array 3 and the focal position of each lens 3a do not need to be uniform but may vary as needed from one lens 3a to another. In particular, it is preferable that the pitch and the focal position vary so that the focal position of each of the lenses 3a of the fry-eye lens array 3 is the diffusing position of the diffuser panel 52.

In FIG. 9, the distance from a lens 3a of the fry-eye lens array 3 in the central part of the liquid crystal module 51 to the diffusing surface of the diffuser panel 52 is longer than the distance from a lens 3a of the fry-eye lens array 3 at either end of the liquid crystal module 51, the focal length of the lens in the central part is set to be longer than that of the lens at either end.

The diffuser panel 52 has a role to expand angle characteristics so that light having passed through the liquid crystal panel 1 can be recognized from anywhere by an observer, and is just equivalent to the screen of a projection display device. Therefore, as in the present embodiment, the diffused panel 52 does not need to have a planar surface but may have a curved surface.

(Features)

A point of great different between the present embodiment and Embodiments 1 to 4 is that as mentioned above, the diffuser panel 52, which is equivalent to the screen, does not have a planar surface but has a curved surface with a curvature and the characteristics of the lenses 3a of each fry-eye lens array 3 that condense rays of light onto the diffuser panel 52 vary with location.

In the multi-display device 501 thus configured, rays of light emitted from the light source section 2 pass through the fry-eye lens array 3, thereby passing through the liquid crystal pixels 6 in the liquid crystal panel 1 that correspond respectively to the lenses 3a of the fry-eye lens array 3. It should be noted here that the rays of light emitted from the light source section 2 strike the lenses 3a of the fry-eye lens array 3 at different angles, respectively, and even after passage through the lenses 3a, the rays of light are condensed on the diffusing surface of the diffuser panel 12 in different principal ray directions, respectively. Therefore, the rays of light having passed through the liquid crystal panel 1 are condensed on the diffusing surface of the diffusing element and each condensed into a region that is larger as a whole than the display screen of the liquid crystal module.

Therefore, in the multi-display device 501 thus configured, even when the diffused panel 52 has a curved surface, it is possible to keep a satisfactory condensation state in any place on the diffuser panel 52 and display an image with high resolution.

(Effects)

With attention focused on rays of light that are condensed at their respective positions on the diffuser panel 52 in the multi-display device 501 according to the present embodiment, rays of light emitted from the light source section 2 pass through the fry-eye lens array 3, thereby passing through their corresponding pixels of the liquid crystal panel 1, respectively. That is, in the liquid crystal panel 1, the amounts of rays of light that pass through the picture elements of each liquid crystal pixel 1 are adjusted so that rays of light transmitted by the pixels are given items of image information, respectively, and condensed on the diffuser panel 52. At this point in time, although the diffusing element has a curved surface, a satisfactory condensation state can be achieved in any place by varying the characteristics of each of the lenses 3a of the fry-eye lens array 3. Further, on the diffuser panel 52, the rays of light having passed through the liquid crystal panel 1 of the liquid crystal module 51 are each condensed in a region that is larger as a whole than the display screen.

While what has so far been mentioned concerns the module A. Exactly the same applies to a module B that is adjacent to the module A. That is, rays of light having passed through the liquid crystal panel of the module B are each condensed into a region (diffusing surface of the diffuser panel 12) that is larger as a whole than the display screen. Since the diffuser panel 52 has a curved surface, the two modules A and B do not need to be placed on the same plane as each other, but are preferably placed at a slant as needed. For this reason, the frame section 5 of each of the modules A and B does not need to be perpendicular to the plane on which the light source sections 2 are placed, but is preferably at a slant as needed.

The major feature of the present embodiment is that while the diffuser panel 52 that an observer views has a curved surface, the part of the liquid crystal panel 1 which modulates an image can be achieved in the form of a planar surface. This makes it possible to suppress an extreme increase in cost of manufacturing the liquid crystal panel 1 and achieve a flexible multi-display device 501. Although, in FIG. 9, the diffuser panel 52 has a curved surface that is convex toward the observer with respect the liquid crystal modules 51, but may have a curved surface concaved toward the liquid crystal modules 51. In this case, too, a satisfactory condensation state can be achieved by varying the characteristics of each of the lenses 3a of the fry-eye lens array 3.

### Embodiment 6

Still another embodiment of the present invention is described below.

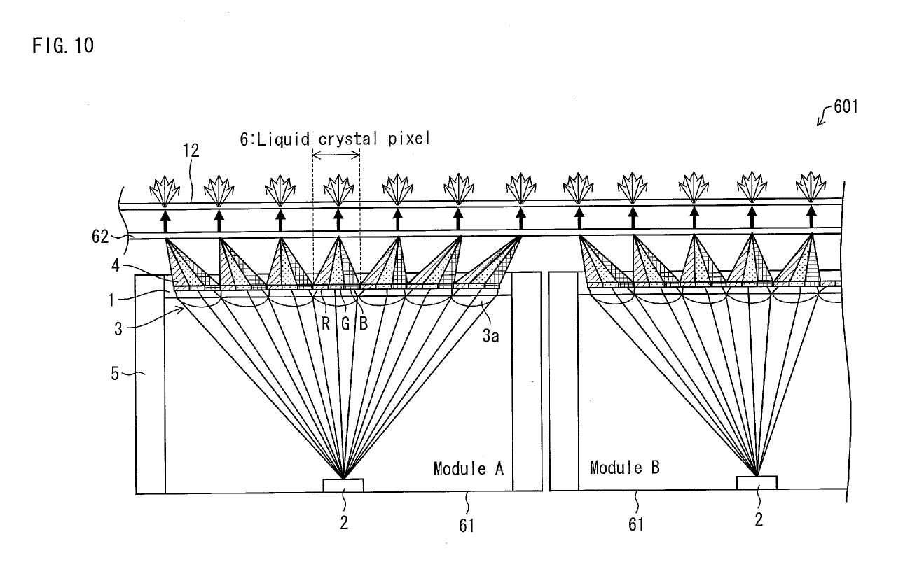

FIG. 10 shows a schematic cross-sectional view of a multi-display device 601 according to the present embodiment.

As shown in FIG. 10, the multi-display device 601, as with the multi-display device 101 of Embodiment 1, is constituted by a parallel arrangement of liquid crystal modules 61.

(Details of the Liquid Crystal Modules 61)

Each of the liquid crystal modules 61 has substantially the same configuration as a liquid crystal module 11 described above in Embodiment 1, but differs greatly therefrom in that a Fresnel lens 62 is provided facing a light incidence plane of the diffuser panel 12.

That is, the liquid crystal module 61 thus configured has a Fresnel lens 62 near the light incidence plane of the diffuser panel 12, and the Fresnel lens 62 has its focal position near the light source section 2.

It should be noted here that the lenses 3a of the fry-eye lens array 3 provided in the liquid crystal module 61 are configured to cause rays of light emitted from the light source section 2 to be condensed by the Fresnel lens 62 at a pitch that is wider than the pitch between liquid crystal pixels arranged on the liquid crystal panel 1.

(Effects)

An effect that is brought about by adding a Fresnel lens 62 is described here.

In the absence of a Fresnel lens (e.g. in the case of a liquid crystal module 11 (FIG. 1) of the aforementioned embodiment), an angular distribution of rays of light passing through each pixel of the liquid crystal panel 1 varies from one pixel to another depending on positions on the diffuser panel 12 which the rays of light reach.

On the other hand, in the case of the addition of a Fresnel lens 62 as in the present embodiment, rays of light passing through each liquid crystal pixel 6 of the liquid crystal panel 1 reach the diffuser panel 12 with substantially the same angular distributions after passing though the Fresnel lens 62, as the Fresnel lens 62 has its focal position on the light source section 2. This makes it possible to easily bring the diffusion angular characteristics of each item of pixel information into conformity with that of another item of pixel information, thus bringing about a remarkable effect of allowing an observer who looks at the multi-display device 601 to view a satisfactory image from any angle.

A multi-display device of the present invention is a multi-display device having a parallel and tiling arrangement of transmissive image modulation elements each having a plane arrangement of pixels, including: light source sections, located directly below centers of image display surfaces of the image modulation elements, which shine light on the image modulation elements, respectively; a diffusing element, located facing sides of the image modulation elements that face away from the light source sections, which diffuses the light thus shone; and imaging optical elements, located between the image modulation elements and the diffusing element, which cause rays of light emitted from the light source sections and transmitted through the image modulation elements to be condensed on the diffusing element at a pitch that is wider than a pixel pitch of the image modulation elements.

According to the foregoing configuration, rays of light from the image modulation elements are diffused in different directions by the diffusing element in the same plane. That is, an observer who looks at the multi-display device does not recognize display screens of the image modulation elements, but recognizes a diffusing surface of the diffusing element, i.e. the outermost/topmost surface of the multi-display device.

Moreover, since the imaging optical elements cause rays of light emitted from the light source sections, located directly below centers of image display surfaces of the image modulation elements, and transmitted through the image modulation elements to be condensed on the diffusing element at a pitch that is wider than a pixel pitch of the image modulation elements, a display screen that is formed on the diffusing element is larger as a whole than the display screens of the image modulation elements.

At this point in time, in a case where, on the diffusing element, the gap between the position of condensation of pixel information on the outermost circumference of an image modulation element and the position of condensation of pixel information on the outermost circumference of another image modulation element adjacent to the image modulation element is substantially equal to the gap between the position of condensation of each item of pixel information and the position of condensation of the other item of pixel information in each of the image modulation elements, an observer who looks at the multi-display device becomes able to recognize images having passed through the two image modulation elements as if they were a single item of image information.

Further, since the imaging optical elements cause the items of pixel information on the respective image modulation elements to be condensed at substantially one point on a diffusing surface of the diffusing element, it becomes possible to display an image with high resolving power.

For the reasons stated above, the multi-display device thus configured brings about a remarkable effect of eliminating the use of conventional means (such as the upright imaging means) that would invite cost increases and of, with a simple configuration, making the seams between image modulation elements less conspicuous and giving a satisfactory feeling of resolution.

The multi-display device is configured such that: the image modulation elements each include a plurality of pixels placed at a predetermined pitch from each other, the pixels each including a plurality of picture elements corresponding to their respective colors; and the imaging optical elements each have a lens array having a plurality of lenses placed at a predetermined pitch from each other, the lenses causing the rays of light emitted from the light source sections to be condensed on the diffusing element at a pitch that is wider than an array pitch between each of the pixels of the image modulation elements and the other.

According to the foregoing configuration, the imaging optical elements each have a lens array having a plurality of lenses placed at a predetermined pitch from each other, the lenses causing the rays of light emitted from the light source sections to be condensed on the diffusing element at a pitch that is wider than an array pitch between each of the pixels of the image modulation elements and the other. This causes the rays of light to be made larger as a whole than the display screen of a single image modulation element to be each condensed on the diffusing surface of the diffusing element to display a color image.

In this way, the display screen of each image modulation element is projected in an enlarged manner on the diffusing surface of the diffusing element, i.e. the outermost/topmost surface of the multi-display device. This eliminates the need to make the space between adjacent image modulation elements narrower than necessary, and makes a seamless large-screen display possible.

Moreover, since the imaging optical elements cause the items of pixel information on the respective image modulation elements to be condensed at substantially one point on the diffusing surface of the diffusing element, a color mixture of adjacent image modulation elements with each other is eliminated, so that it becomes possible to display an image with high resolving power.

The multi-display device is configured such that: the light source sections are each constituted by light-emitting sections that emit rays of light at different dominant wavelengths from each other; the image modulation elements each include a plurality of pixels placed at a predetermined pitch from each other, the pixels each including a plurality of picture elements corresponding to their respective colors; and the imaging optical elements each have a lens array having a plurality of lenses placed at a predetermined pitch from each other, the lenses causing rays of light emitted from the light-emitting sections to be separated by color, causing the rays of light thus separated to pass through the picture elements constituting the pixels of the image modulation elements respectively, and causing the rays of light to be condensed on the diffusing element at a pitch that is wider than an array pitch between each of the pixels of the image modulation elements and the other.

According to the foregoing configuration, rays of light emitted the light-emitting sections that emit rays of light at different dominant wavelengths from each other pass through the lens arrays, thereby passing through their corresponding picture elements constituting the pixels of the image modulation elements, respectively, and the color of each pixel can be expressed by adjusting the amount of light that passes through each picture element. This makes it possible to carry out a full-color display without using a color filter.

Therefore, the multi-display device thus configured makes it possible to display an integrated image without causing an observer to view a seam between liquid crystal modules, and to achieve lower electric power consumption by drastically reducing an optical loss that is absorbed by a color filter.

The multi-display device is configured such that: the image modulation elements are each divided into a plurality of blocks; the light source sections are located directly below centers of regions on display screens of the image modulation elements that correspond to the blocks, respectively; the image modulation elements each include a plurality of pixels placed at a predetermined pitch from each other, the pixels each including a plurality of picture elements corresponding to their respective colors; and the imaging optical elements each have a lens array having a plurality of lenses placed at a predetermined pitch from each other, the lenses causing the rays of light emitted from the light source sections to be condensed on the diffusing element and to be condensed at the pitch that is wider than the array pitch between each of the pixels of the image modulation elements and the other.

According to the foregoing configuration, in each of the blocks, rays of light emitted from the light source section pass through the lens array, thereby passing through the pixels of the image modulation element that correspond respectively to the lenses of the lens array. It should be noted here that the rays of light emitted from the light source section strike the lenses of the lens array 3 at different angles, respectively, and even after passage through the lenses, the rays of light are condensed on the diffusing surface of the diffusing element in different principal ray directions, respectively.

Therefore, since the rays of light having passed through the image modulation element are condensed on the diffusing surface of the diffusing element, they are made larger as a whole than the size of a single block constituting the image modulation element to be each condensed on the diffusing surface of the diffusing element.

Therefore, the distance between an image modulation element and a light source section can be better shorten by a parallel and tiling arrangement of image modulation elements each divided into a plurality of blocks than by a parallel and tiling arrangement of image modulation elements each not divided into a plurality of blocks. This makes it possible to achieve a reduction in the thickness of the multi-display device.

The multi-display device is preferably configured to further include a light-blocking member placed in a space between each of the blocks and the other.

According to the foregoing configuration, the light-blocking member placed in a space between each of the blocks and the other can prevent light from a light source section corresponding to a single block from striking an adjacent block.

This prevents the lenses constituting the lens array from being struck by light from a light-emitting section of a block other than the block for which the light array is responsible, thereby making it possible to display an image with high resolving power. This makes it possible to prevent a reduction in display quality of an image.

The multi-display device is preferably configured such that the image modulation elements do not transmit light in a region corresponding to the space between each of the blocks and the other.

According to the foregoing configuration, the image modulation elements do not transmit light in a region corresponding to the space between each of the blocks and the other. This makes it possible to prevent light from a light source section corresponding to a single block from striking an adjacent block.

This prevents the lenses constituting the lens array from being struck by light from a light-emitting section of a block other than the block for which the light array is responsible, thereby making it possible to display an image with high resolving power. This makes it possible to prevent a reduction in display quality of an image.

Moreover, although the number of pixels that are displayed on the diffusing element is smaller than the total number of pixels of the plurality of image modulation elements, it becomes possible to divert existing liquid crystal modules as the image modulation elements.

The multi-display device is preferably configured such that in the region corresponding to the space between each of the blocks and the other, the image modulation elements each have any one of the following: a member constituting a TFT; a black mask layer of a color filter; a member for retaining a thickness between liquid crystal layers; and a combination of any of the above.

According to the foregoing configuration, in the region corresponding to the space between each of the blocks and the other, the image modulation elements each have any one of the following: a member constituting a TFT; a black mask layer of a color filter; a member for retaining a thickness between liquid crystal layers; and a combination of any of the above. This makes it possible to prevent light from a light source section corresponding to a single block from striking an adjacent block.

This prevents the lenses constituting the lens array from being struck by light from a light-emitting section of a block other than the block for which the light array is responsible, thereby making it possible to display an image with high resolving power. This makes it possible to prevent a reduction in display quality of an image.

Moreover, this makes it possible to match the number of pixels that are displayed on the diffusing element and the total number of pixels of the plurality of image modulation elements.

The multi-display device is preferably configured such that in each of the image modulation elements, the pitch between each of the pixels and the other is wider than the pitch between each of the picture elements constituting the pixels and the other.

According to the foregoing configuration, in each of the image modulation elements, the pitch between each of the pixels and the other is wider than the pitch between each of the picture elements constituting the pixels and the other. This prevent such a defect that when light passing through the lens of the lens array that exits on the leftmost side of the image modulation element passes through the pixel that exists on the leftmost side in the image modulation element, the amount of a ray of light that passes through an opening in the blue (B) picture element is smaller than the amount of a ray of light that passes through an opening in the green (G) picture element.

The multi-display device is preferably configured such that: P is the predetermined pitch at which the rays of light are condensed on the diffusing element; (1/n) is the imaging scale ratio of each of the imaging optical elements; P1 is the pitch between light source sections of the same color; P1≈n×P; P2 is the lens pitch of the lens array of each of the imaging optical elements; and P2≈(n/(n+1))×p.

According to the foregoing configuration, rays of light having passed through a plurality of lens arrays are condensed at one point. This makes it possible to cause an observer to view a seamless integrated image display in the case of a parallel arrangement of image modulation elements and, at the same time, brings about an effect of averaging out individual differences among the light source sections.

This makes the variation between the LEDs inconspicuous to an observer who looks at the multi-display device as a whole. This makes it possible to improve display image quality.

The multi-display device is preferably configured such that the diffusing element is constituted by a parallel arrangement of sheets each having an end face in a region where no light is condensed.

According to the foregoing configuration, for example, in the case of a large-screen display device made by a parallel arrangement of projectors, the diffusing element, which is equivalent to the outermost/topmost screen, must be even across all display regions. That is, for example, in the case of a larger-screen display device measuring 120 inches diagonally, the diffusing element needs to have a size measuring 120 inch diagonally. This invites an expansion in manufacturing cost.

However, as in the foregoing configuration, on the diffusing element, which corresponds to the screen, the items of pixel information (or items of picture element information) are condensed separately from each other, so that there appears a region between each point of condensation and the other where a ray of light does not reach. Even if the diffusing element has its end face in the region where a ray of light does not reach, a ray of light from an image modulation element is not affected at all, and therefore does not affect image display quality.

Therefore, in the case of a large-screen display device measuring 120 inches diagonally, the diffusing element can be achieved, for example, by a 6×6 parallel arrangement of diffusing elements each measuring 20 inches diagonally, so that the cost of manufacturing the diffusing element is expected to be dramatically reduced as compared with the foregoing.

The multi-display device is preferably configured such that each of the imaging optical elements has a focal length that varies with distance from that imaging optical element to the diffusing element.

According to the foregoing configuration, each of the imaging optical elements has a focal length that varies with distance from that imaging optical element to the diffusing element. This increases the degree of freedom in the shape of the diffusing element. That is, even when the diffusing element is formed to have a curved surface, image information can be appropriately condensed on the diffusing surface of the diffusing element.

Moreover, while the diffusing element that an observer views has a curved surface, the part of the image modulation element which modulates an image can be achieved in the form of a planar surface. This makes it possible to suppress an extreme increase in cost of manufacturing the image modulation element and achieve a flexible multi-display device.

The multi-display device is preferably configured such that the diffusing element has either a planar surface or a curved surface having a curvature.

According to the foregoing configuration, regardless of the shape of the diffusing element, the part of the image modulation element which modulates an image can be achieved in the form of a planar surface. This makes it possible to suppress an extreme increase in cost of manufacturing the image modulation element and achieve a flexible multi-display device.

The multi-display device is preferably configured to further include a Fresnel lens near a light incidence plane of the diffusing element, the Fresnel lens having its focal position near the light source sections, wherein the lenses of the lens arrays cause the rays of light emitted from the light source sections to be condensed on the Fresnel lens at the pitch that is wider than the array pitch between each of the pixels of the image modulation elements and the other.

According to the foregoing configuration, in the absence of a Fresnel lens, an angular distribution of rays of light passing through each pixel of the image modulation element varies from one pixel to another depending on positions on the diffusing element which the rays of light reach. On the other hand, in the case of the addition of a Fresnel lens, rays of light passing through each pixel of the image modulation element reach the diffusing element with substantially the same angular distributions after passing though the Fresnel lens, as the Fresnel lens has its focal position near the light source section. This makes it possible to easily bring the diffusion angular characteristics of each item of pixel information into conformity with that of another item of pixel information, thus bringing about a remarkable effect of allowing an observer who looks at the multi-display device to view a satisfactory image from any angle.

A display module of the present invention a transmissive image modulation element having a plane arrangement of pixels; a light source section, located directly below a center of an image display surface of the image modulation element, which shines light on the image modulation elements; a diffusing element, located facing a side of the image modulation element that faces away from the light source section, which diffuses the light thus shone; and an imaging optical element, located between the image modulation element and the diffusing element, which causes rays of light emitted from the light source section and transmitted through the image modulation element to be condensed on the diffusing element at a pitch that is wider than a pixel pitch of the image modulation element.

According to the display module thus configured, since image information obtained by enlarging the display screen of an image modulation element is displayed on the diffusing surface of the diffusing element that an observer observes, the image information displayed can be enlarged onto the frame provided around the image modulation element. This makes it possible to easily achieve a frameless display module.

The multi-display device may be configured such that each of the imaging optical elements causes an item of image information or an item of picture element information from an adjacent image modulation element or, when each of the image modulation elements is divided into a plurality of blocks, from an adjacent block to be condensed at one place on the diffusing element.

In this case, images of adjacent image modulation elements (or adjacent blocks) can be partially overlapped. This brings about an effect of making individual differences in light source sections among image modulation element (or among blocks) inconspicuous by smoothing the individual differences.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to a multi-display device which makes a large-screen display possible by arranging a plurality of liquid crystal modules in a tiling manner and which requires a high feeling of resolution.

### REFERENCE SIGNS LIST

1 Liquid crystal panel (image modulation element)
2 Light source section (light-emitting section)
3 Fry-eye lens array (imaging optical element)
3a Lens
4 CF panel
5 Frame section
6 Liquid crystal pixel
7 Light-blocking section
11 Liquid crystal module
12 Diffuser panel
21 Liquid crystal module
21a Block
31 Liquid crystal module
32 Light source section
41 Liquid crystal module
51 Liquid crystal module
52 Diffuser panel
61 Liquid crystal module
62 Fresnel lens
101 Multi-display device
201 Multi-display device
301 Multi-display device
401 Multi-display device
501 Multi-display device
601 Multi-display device

1. A multi-display device having a parallel and tiling arrangement of transmissive image modulation elements each having a plane arrangement of pixels, comprising:
light source sections, located directly below centers of image display surfaces of the image modulation elements, which shine light on the image modulation elements, respectively;
a diffusing element, located facing sides of the image modulation elements that face away from the light source sections, which diffuses the light thus shone; and
imaging optical elements, located between the image modulation elements and the diffusing element, which cause rays of light emitted from the light source sections and transmitted through the image modulation elements to be condensed on the diffusing element at a pitch that is wider than a pixel pitch of the image modulation elements.

2. The multi-display device as set forth in claim 1, wherein:
the image modulation elements each include a plurality of pixels placed at a predetermined pitch from each other, the pixels each including a plurality of picture elements corresponding to their respective colors; and
the imaging optical elements each have a lens array having a plurality of lenses placed at a predetermined pitch from each other, the lenses causing the rays of light emitted from the light source sections to be condensed on the diffusing element at a pitch that is wider than an array pitch between each of the pixels of the image modulation elements and the other.

3. The multi-display device as set forth in claim 1, wherein:
the light source sections are each constituted by light-emitting sections that emit rays of light at different dominant wavelengths from each other;
the image modulation elements each include a plurality of pixels placed at a predetermined pitch from each other, the pixels each including a plurality of picture elements corresponding to their respective colors; and
the imaging optical elements each have a lens array having a plurality of lenses placed at a predetermined pitch from each other, the lenses causing rays of light emitted from the light-emitting sections to be separated by color, causing the rays of light thus separated to pass through the picture elements constituting the pixels of the image modulation elements respectively, and causing the rays of light to be condensed on the diffusing element at a pitch that is wider than an array pitch between each of the pixels of the image modulation elements and the other.

4. The multi-display device as set forth in claim 2, wherein:
the image modulation elements are each divided into a plurality of blocks;
the light source sections are located directly below centers of regions on display screens of the image modulation elements that correspond to the blocks, respectively; and
the lenses cause the rays of light emitted from the light source sections to be condensed on the diffusing element and to be condensed at the pitch that is wider than the array pitch between each of the pixels of the image modulation elements and the other.

5. The multi-display device as set forth in claim 4, further comprising a light-blocking member placed in a space between each of the blocks and the other.

6. The multi-display device as set forth in claim 4, wherein the image modulation elements carry out a black display in a region corresponding to the space between each of the blocks and the other.

7. The multi-display device as set forth in claim 4, wherein in the region corresponding to the space between each of the blocks and the other, the image modulation elements each have any one of the following: a member constituting a TFT; a black mask layer of a color filter; a member for retaining a thickness between liquid crystal layers; and a combination of any of the above.

8. The multi-display device as set forth in claim 2, wherein in each of the image modulation elements, the pitch between each of the pixels and the other is wider than the pitch between each of the picture elements constituting the pixels and the other.

9. The multi-display device as set forth in claim 2, wherein:
P is the predetermined pitch at which the rays of light are condensed on the diffusing element;
(1/n) is the imaging scale ratio of each of the imaging optical elements;
P1 is the pitch between light source sections of the same color;
P1≈n×P;
P2 is the lens pitch of the lens array of each of the imaging optical elements; and
P2≈(n/(n+1))×P.

10. The multi-display device as set forth in claim 2, wherein the diffusing element is constituted by a parallel arrangement of sheets each having an end face in a region where no light is condensed.

11. The multi-display device as set forth in claim 2, wherein each of the imaging optical elements has a focal length that varies with distance from that imaging optical element to the diffusing element.

12. The multi-display device as set forth in claim 11, wherein the diffusing element has either a planar surface or a curved surface having a curvature.

13. The multi-display device as set forth in claim 2, further comprising a Fresnel lens near a light incidence plane of the diffusing element, the Fresnel lens having its focal position near the light source sections, wherein
the lenses of the lens arrays cause the rays of light emitted from the light source sections to be condensed on the Fresnel lens at the pitch that is wider than the array pitch between each of the pixels of the image modulation elements and the other.

14. The multi-display device as set forth in claim 2, wherein each of the imaging optical elements causes an item of image information or an item of picture element information from an adjacent image modulation element or, when each of the image modulation elements is divided into a plurality of blocks, from an adjacent block to be condensed at one place on the diffusing element.

15. A display module comprising:
a transmissive image modulation element having a plane arrangement of pixels;
a light source section, located directly below a center of an image display surface of the image modulation element, which shines light on the image modulation elements;
a diffusing element, located facing a side of the image modulation element that faces away from the light source section, which diffuses the light thus shone; and
an imaging optical element, located between the image modulation element and the diffusing element, which causes rays of light emitted from the light source section and transmitted through the image modulation element to be condensed on the diffusing element at a pitch that is wider than a pixel pitch of the image modulation element.
